(19) United States
(12) Patent Application Publication
(10) Pub. No.: US 2014/0107904 A1
(43) Pub. Date: Apr. 17, 2014

(54) Method for determining a starting position of a cyclic movement

(71) Applicants: Ulrich-Michael Nefzer, Weinstadt (DE); Thomas Grundler, Benningen (DE); Carsten Deringer, Aichwald (DE); Jochen Quante, Ludwigsburg (DE)

(72) Inventors: Ulrich-Michael Nefzer, Weinstadt (DE); Thomas Grundler, Benningen (DE); Carsten Deringer, Aichwald (DE); Jochen Quante, Ludwigsburg (DE)

(21) Appl. No.: 14/110,560

(22) PCT Filed: Feb. 28, 2012
(86) PCT No.: PCT/EP12/53305

§ 371 Date: Dec. 30, 2013

(30) Foreign Application Priority Data
Apr. 12, 2011 (DE) 10 2011 007 174.1

(51) Int. Cl. F02D 45/00

(52) U.S. Cl. CPC F02D 45/00
USPC 701/101

(57) ABSTRACT

A method for determining an initial position of a cyclic motion, includes: recording successive encoder signals to obtain a signal sequence; continuously comparing the recorded signal sequence with a group of possible signal sub-sequences of a reference signal sequence encompassing a sequence of signal positions for at least one complete motion cycle, each of the signal sub-sequences being associated with one or more possible initial positions of the cyclic motion; eliminating one or more signal sub-sequences which do not coincide with the signal sequence or whose initial portions do not coincide with the signal sequence; and determining as the initial position one of the initial positions that are associated with the possible remaining signal sub-sequence.

### BACKGROUND OF THE INVENTION

1. Field of the Invention

The invention relates to a method and an apparatus for position sensing, for example for sensing the position of a camshaft in a motor vehicle.

2. Description of the Related Art

When an internal combustion engine in a motor vehicle is started, it is categorically desirable to detect the exact position of the pistons in the cylinders as quickly as possible, as soon as the starter turns the engine.

In particular in the context of start-stop systems in motor vehicles, in which an internal combustion engine is shut off when the motor vehicle is at a standstill and is not started again until it drives off, it is important to determine the initial position of the engine, i.e. the position of the pistons in the cylinders, upon starting as quickly and reliably as possible, as soon as the starter turns the engine.

The published European patent application document EP 1 882 839 A1 describes a method for determining a position of an internal combustion engine. Position sensors that each have an encoder wheel are provided on the camshaft and on the crankshaft. The position sensors generate, as a function of the positions of the camshaft and of the crankshaft, position signals that can be evaluated. From the camshaft position signal and from the crankshaft position signal, which moreover has a synchronization feature, an indication is derived regarding the position of the internal combustion engine as a function of an edge of the camshaft position signal, an edge of the crankshaft position signal, and the synchronization signal.

### BRIEF SUMMARY OF THE INVENTION

According to a first aspect, the method for determining an initial position of a cyclic motion encompasses the following steps:
recording successive encoder signals in order to obtain a signal sequence;
continuously or regularly comparing the recorded signal sequence with a group of possible signal sub-sequences of a provided reference signal sequence, the reference signal sequence encompassing a signal sequence made up of signal positions for at least one complete motion cycle, the signal sub-sequences of the reference signal sequence each being associated with one or more possible initial positions of the cyclic motion;
eliminating one or more signal sub-sequences from the group of possible signal sub-sequences which do not coincide with the signal sequence or whose initial portions do not coincide with the signal sequence; and
determining as the initial position one of the initial positions that are associated with the possible remaining signal sub-sequences.

The above method serves to ascertain particularly quickly an initial position of a cyclic motion. For that purpose the method makes provision for eliminating as possible initial positions for the cyclic motion, from a reference signal sequence that has starting positions for signal sub-sequences that each have an encoder wheel position associated with them, those encoder wheel positions in which the signal sub-sequence does not coincide or no longer coincides with the previously recorded signal sequence. The signal sub-sequences that are associated with the eliminated encoder wheel positions are then no longer taken into account in the next comparison of the signal sequence with the signal sub-sequences.

Multiple signal sub-sequences, or also only one, can remain. “Remain” means here that a signal sub-sequence has not been eliminated due to lack of coincidence. Multiple initial positions, or also only one, can remain, i.e. only one initial position can be associated with the remaining signal sub-sequence or sub-sequences. If only one initial position remains, it is determined as the initial position.

Recording of the signal sequence is continued while the method is being carried out, and the possible encoder wheel positions are thus gradually eliminated as possible initial positions. The total duration of the method until determination of the initial position can thereby be reduced, since for each newly recorded encoder signal just recorded, only the newly arrived data for those initial positions which are so far still possible need to be checked.

With the known algorithms for pattern recognition, on the other hand, at each call the currently provided signal sequence is compared with the reference signal sequence for each initial position. This procedure is more laborious, and increases the time until the initial position of the camshaft rotation is identified.

Provision can be made that recording of the signal sequence is begun after a start of the motion is identified. In the case of a start-stop system, for example, the initial position of the camshaft can thus be determined as soon as a rotation of the engine is identified, e.g. as soon as the fact that a starter has begun to turn the engine is identified.

The method can further provide that the recording of encoder signals, comparison of the recorded signal sequence with the group of possible signal sub-sequences of the reference signal sequence, and elimination of one or more signal sub-sequences from the group of possible signal sub-sequences that do not coincide with the signal sequence or whose initial parts do not coincide with the signal sequence, are repeated cyclically. It is thereby possible, with every new arriving encoder signal, to eliminate signal sub-sequences that can no longer match, so that an unequivocal initial position for the motion can be determined after the smallest possible number of recorded encoder signals.

The number of encoder signals of the recorded signal sequence that coincide with a possible signal sub-sequence of the reference signal sequence can be stored as a label value for the initial position associated with that signal sub-sequence. The most recently recorded encoder signal of the recorded signal sequence can then be compared with the digit of each possible signal sub-sequence which follows the label value of the associated initial position. It is thereby possible, with little calculation outlay, to label the digit of the associated signal sub-sequence for each still-matching initial position up to which coincidence with the recorded signal sequence has been identified. Each newly recorded encoder signal can therefore be compared directly with the corresponding digit of the signal sub-sequence for each initial position that still matches.

A reverse search can be carried out if no possible signal sub-sequence and thus no initial position can be determined. The reverse search can encompass comparison of the recorded signal sequence with possible reverse signal sub-sequences that are constituted by reading out the reference signal sequence in the opposite direction. This makes it possible to easily integrate a reverse search into the existing method for position determination, since all that needs to be changed with respect to the forward search is the read-out direction of the reference signal sequence.

According to an embodiment, the method described above is used to determine the position of a camshaft of an internal combustion engine. The encoder signals can encompass: the presence or absence of a gap in a crankshaft encoder wheel, and/or the presence and/or an angle of an edge of a camshaft encoder wheel, and/or a length and/or a level of a segment of the camshaft encoder wheel.

Recording of the encoder signals can be carried out firstly with a greater number of encoder signals per motion cycle, and as the method proceeds a smaller number of encoder signals per motion cycle can then be recorded. The initial position can thereby be determined quickly and with high accuracy after the motion starts. As the motion continues, the position of the camshaft can then be monitored with little calculation outlay.

Recording of the encoder signals can be carried out, for example, at least eight times and at most 30 times per motion cycle.

Also constituting an embodiment of the present invention is an apparatus encompassing an internal combustion engine and a control unit, the control unit being embodied in such a way that it carries out the method described above for determining the initial position of the motion of the internal combustion engine.

Lastly, an embodiment of the present invention is constituted by a computer program product that contains a program code that, when it is executed on a data processing device, carries out the method described above.

### BRIEF DESCRIPTION OF THE DRAWINGS

FIG. 1 schematically depicts an engine in which the method according to the present invention for determining the initial position can be utilized.

FIG. 2 is a flow chart of an embodiment of the method according to the present invention for position determination.

FIG. 3 shows an example of determination of an initial position using the method according to the present invention.

### DETAILED DESCRIPTION OF THE INVENTION

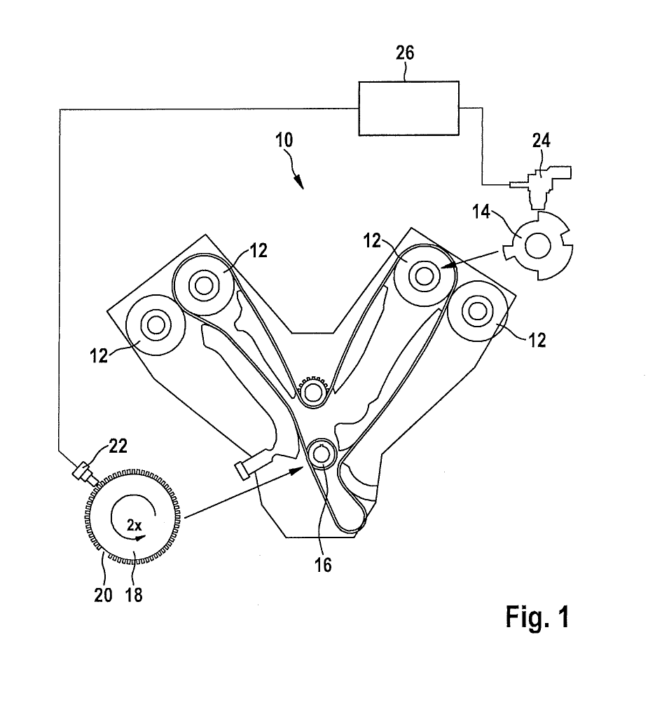

FIG. 1 is a schematic depiction of a V-engine 10 having four camshafts 12. Mounted on one camshaft 12 is a camshaft encoder wheel 14 that has a characteristic and unequivocal, as a rule non-regular pattern. The pattern can be embodied by elevations in a radial direction having different tangential widths, by marks on the camshaft encoder wheel 14, or in another manner.

Likewise disposed on crankshaft 16 of engine 10 is a crankshaft encoder wheel 18 for detecting a relative change in location, which wheel has at one circumferential position a mark for characterizing one complete revolution. For example, crankshaft encoder wheel 18 can have regularly spaced marks or structures, a characteristic gap 20 being provided at one position. Crankshaft encoder wheel 18 can be embodied, for example, as a gear wheel having a specific number of teeth, such as e.g. 60 or another number, one or more mutually adjacent teeth being absent in order to constitute the mark at the circumferential position.

By way of optical, magnetic, or electrical sensors 22, 24, upon a motion of camshaft 12 successive encoder signals can be recorded as a function of the change in position of camshaft encoder wheel 14, and/or upon a motion of crankshaft 16 successive encoder signals can be recorded as a function of the change in position of crankshaft encoder wheel 18, and can be provided to a control unit 26. To allow detection of the initial position of the engine as quickly as possible, camshaft encoder wheel 14 can generate, for example, between eight and 30 encoder signals per revolution of the camshaft.

The phase angles of camshaft encoder wheel 14 and of crankshaft encoder wheel 18 have a defined relationship to one another, since camshaft encoder wheel 14 and crankshaft encoder wheel 18 move synchronously with respect to one another, although crankshaft encoder wheel 18 has twice the rotational speed of camshaft encoder wheel 14.

The regularly successive edges of the encoder signal recorded at crankshaft encoder wheel 18 can thus serve as a clock for picking up the levels of the encoder signals from sensor 24 in order to record the encoder signal of camshaft encoder wheel 14. For example, a level of camshaft encoder wheel 14 is determined respectively after a predetermined number of edges, e.g. after every, every second, or every n-th edge of the encoder signal recorded with crankshaft encoder wheel 18. Alternatively, the presence or absence of an edge of the encoder signal of camshaft encoder wheel 14 can be sensed at each edge or at a predetermined number of edges of the encoder signal recorded at crankshaft encoder wheel 18, and the length of the current segment of camshaft encoder wheel 14 can thus be determined. It is thereby possible to ensure that a defined number of encoder signals of camshaft encoder wheel 14 can be recorded for each motion cycle, even when the rotation speed of engine 10 is changing. Furthermore, the number of edges of the encoder signal sensed by sensor 22 of crankshaft encoder wheel 18, or an indication corresponding thereto, between each two edges of the encoder signal sensed by sensor 24 of camshaft encoder wheel 14 can be counted, and a sequence of the correspondingly counted numbers of edges can be recorded as a signal sequence.

For a constant rotation speed of engine 10, sensor 24 can also be activated at regular time intervals, without using the edges of the encoder signal of crankshaft encoder wheel 18 as a clock for reading out sensor 24.

Camshaft encoder wheel 14 can encompass, for example, multiple segments each of a different height and/or length, and/or edges having different shapes and angles can be provided. Also conceivable is a camshaft encoder wheel 14 having protruding segments, which has a greater radius on a portion of its circumference, e.g. 180°, and a lesser radius on the remaining portion of its circumference, e.g. 180°. A signal corresponding to the presence and/or an angle of edges, and/or to the length and/or height of the current segment, can be recorded as an encoder signal for camshaft encoder wheel 14.

In the case of crankshaft encoder wheel 18, an encoder signal can furthermore indicate the presence or absence of gap 20 in the observed segment.

A signal sequence of successive encoder signals is thus read out as described above during each motion of camshaft 12, the values for the encoder signals being run through cyclically in accordance with a reference signal sequence upon rotation of camshaft 12. This reference signal sequence can generally encompass multiple entries having identical values. For crankshaft encoder wheel 18 the reference signal sequence contains, for example, an entry having the value “gap present,” while all remaining entries have the value “no gap present.” It is therefore generally not possible to determine an unequivocal position of camshaft 12 and/or of crankshaft 16 from a single encoder signal that has been recorded with sensors 22 and/or 24.

A signal sequence corresponding to multiple successive encoder signals of sensor 24 of camshaft encoder wheel 14 is therefore sensed, and that sequence is mapped onto a signal sub-sequence of the reference signal sequence. The initial position of the motion can then be unequivocally determined, since one initial position is associated with each signal sub-sequence of the reference signal sequence. As soon as an initial position is determined, the phase angle and thus the position of the camshaft can be calculated.

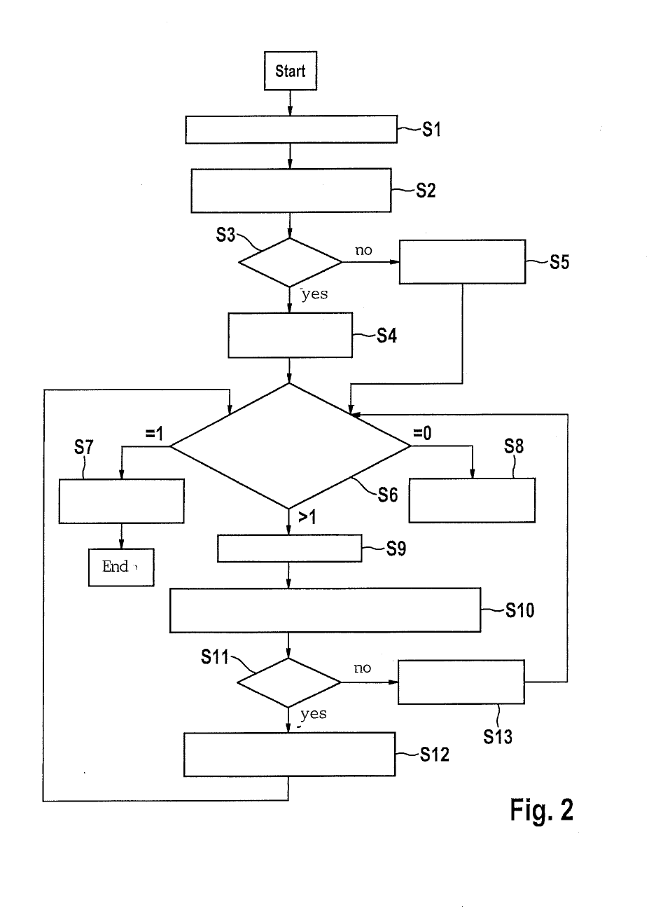

FIG. 2 shows an embodiment of the method according to the present invention. After starting, in step S1 firstly a first encoder signal for camshaft encoder wheel 14 and/or for crankshaft encoder wheel 18 is sensed by reading out sensors 22, 24.

The encoder signal that is used hereinafter for the method shown in FIG. 2 can be a signal value made available directly from sensors 22, 24, for example a value that indicates the presence of an edge in that segment of camshaft encoder wheel 14 which is located opposite sensor 24. An indication that has been ascertained from one or more signal values determined by sensor 24 can also be used as an encoder signal in this context. An example of such an indication is a value for the segment length of that segment of camshaft sensor wheel 14 which is located opposite sensor 24, if said wheel is, as shown in FIG. 1, subdivided in a circumferential direction into segments having different radii.

In step S2, the encoder signal determined in step S1 is then compared, for each initial position, with the first value of the associated signal sub-sequence of the reference signal sequence. If the first encoder signal determined in step S1 is identical to the first value of the signal sub-sequence for an associated initial position (“yes” in step S3), that initial position is labeled in step S4 as matching, with the label value “1”, since so far one encoder signal matches the initial position.

If the encoder signal determined in step S1 is not identical to the first value of the signal sub-sequence for an associated initial position (“no” in step S3), that initial position is labeled in step S5 as non-matching, with the label value “−1”.

Once the comparison with the first encoder signal has occurred for each initial position, and thus each initial position has been labeled either as non-matching (with label value “−1”) or as matching the first encoder signal (with label value “1”), in step S6 the group of all initial positions is investigated in order to ascertain how many initial positions are still labeled as matching and are therefore still contained in the group of possible initial positions.

If exactly one initial position is labeled as matching, and all other initial positions have been labeled as non-matching (result “1” in step S6), the initial position labeled as matching is outputted in step S7 as the initial position, and the method is terminated.

If no initial position is labeled as matching (result “0” in step S6), it is assumed that perhaps engine 10 may be running in reverse, and in step S8 a reverse search is started using the previously recorded signal sequence of encoder signals, said search being described below in detail. (This outcome can occur only after at least two ascertained position-dependent indications, but is mentioned here, for the sake of completely, already after the first call of step S6.)

If more than one initial position is labeled as matching (result “>1” in step S6), in step S9 a further encoder signal is recorded by again reading out at least one of sensors 22, 24.

In step S10, for each initial position that was labeled in step S4 as matching (i.e. with label value “1”), the encoder signal ascertained in step S9 is then compared with the next value of the associated signal sub-sequence.

That digit of the signal sub-sequence which is to be compared with the most recently recorded encoder signal is determined from the label value for the associated initial position: for a label value of 1, one encoder signal has previously been identified as matching, and the encoder signal recorded in step S9 is thus to be compared with the second digit of the signal sub-sequence. As a general rule, for a label value of n, the (n+1)-th digit of the signal sub-sequence is to be compared with the most recently recorded encoder signal.

If the encoder signal recorded in step S9 is identical to the second digit of the signal sub-sequence (“yes” in step S11), then in step S12 the associated initial position is labeled as matching for the two previously recorded encoder signals, with the label value “2”. In general, the label value of the initial position is incremented by 1 if, after comparison with a further encoder signal, the initial position is labeled as still matching.

If the encoder signal recorded in step S9 is not equal to the second digit of the signal sub-sequence (“no” in step S11), the respective initial position is labeled in step S13 as non-matching, with the label value “−1”.

Once all the possible initial positions (i.e. those still labeled as matching) have been processed using the second encoder signal in accordance with steps S10 to S13, the method goes back to step S6 and another check is made as to whether an initial position has in the meantime been unequivocally determined. If more than one initial position is still possible, in step S9 a further encoder signal is recorded and in step S10 it is compared, for each initial position that is still possible, with the corresponding digit of the signal sub-sequence.

Steps S6 and S9 to S13 are repeated either until an initial position has been identified, which is then outputted in step S7, or until an initial position is no longer possible, so that in step S8 a reverse search is started.

The reverse search is carried out similarly to the method described above for the forward search. As compared with the forward search, however, in the reverse search the values of the signal sub-sequence for the respective initial position that are compared with the signal sequence of the recorded encoder signals are read out in the opposite direction from the cyclically repeating reference signal sequence.

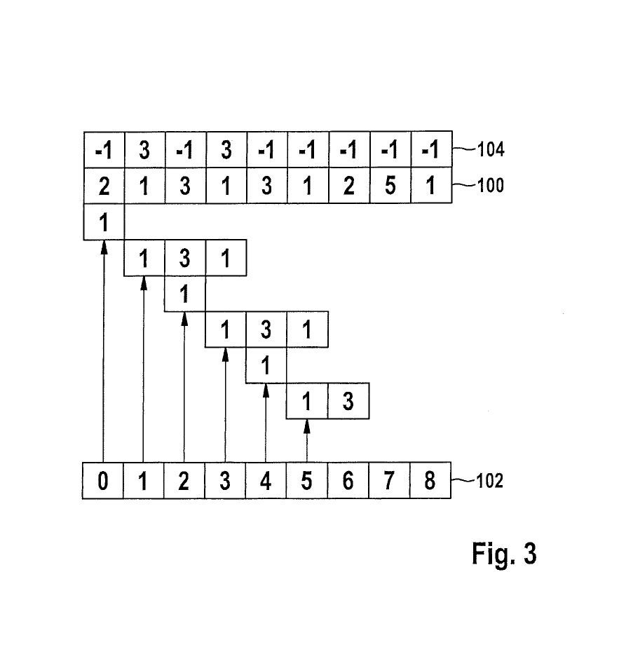

FIG. 3 shows an example of a reference signal sequence 100 for encoder signals for initial positions 102. In the example shown, nine encoder signals of camshaft encoder wheel 14 are recorded for each revolution of camshaft 12. The recorded encoder signals correspond to the lengths of that segment of camshaft encoder wheel 14 which is respectively located opposite sensor 24.

In the example shown, the encoder signals values “1”, “3”, “1” were recorded by sensor 24 for the segment length. As described above, indication of a segment length is one of several possibilities for an encoder signal. When the segment length is indicated as the encoder signal, it is not possible to increase the number of encoder signals per motion cycle. Instead, the number of encoder signals per motion cycle is predefined by the number of segments on the periphery of camshaft encoder wheel 14. The resolution or the sample rate can, however, be increased, so that a decision can be made more quickly as to whether specific segments of the encoder wheel have been seen, e.g. short segments or unequivocally long segments.

When the method is first called, all initial positions 102 are first compared with the first encoder signal “1”. Initial position 0 contains, in the associated signal sub-sequence of reference signal sequence 100, a segment length of “2” as the first value, and is thus labeled as non-matching by the fact that the label value “−1” is entered in hit list 104 for initial position 0. The signal sub-sequence of reference signal sequence 100 for initial position 1 contains a segment length of “1” as the first value. This initial position is therefore still possible, and is therefore initially labeled in hit list 104 with the label value “1”.

Once the entire signal sequence of the recorded encoder signals has been compared with the signal sub-sequences of reference signal sequence 100, hit list 104 contains two entries that correspond to possible initial positions. Initial positions 1 and 3 are each labeled with the label value “3” in hit list 104, since the corresponding signal sub-sequences for these initial positions are coincident with three recorded encoder signals. All other initial positions are labeled as non-matching, with a label value of “−1”.

At the next call of the algorithm, execution jumps only to the possible initial positions that are still labeled as matching. By way of the entries in hit list 104 execution can jump directly to the newly arrived data, since the label value in hit list 104 indicates directly how many values of the corresponding signal sub-sequence of reference signal sequence 100 have already been compared with the recorded encoder signals.

If an unequivocal coincidence is not detected after a certain time, reference signal sequence 100 is compared with the recorded signal sequence for each initial position in the opposite direction, in order to detect an engine running in reverse.

The method described above thus makes possible a very efficient implementation of pattern recognition. It also allows very simple realization of a forward search and reverse search

1-13. (canceled)

14. A method for determining an initial position of a cyclic motion of an apparatus, comprising:
a) recording successive encoder signals in order to obtain a signal sequence;
b) one of continuously or periodically comparing the recorded signal sequence with a group of possible signal sub-sequences of a reference signal sequence, the reference signal sequence encompassing a signal sequence of signal positions for at least one complete motion cycle, and the signal sub-sequences of the reference signal sequence each being associated with at least one possible initial position of the cyclic motion;
c) eliminating, from the group of possible signal sub-sequences, selected signal sub-sequences (i) which do not coincide with the recorded signal sequence or (ii) whose initial portions do not coincide with the recorded signal sequence; and
d) determining as the initial position one of the initial positions associated with the possible remaining signal sub-sequences of the reference signal sequence.

15. The method as recited in claim 14, wherein the recording of the successive encoder signals to obtain the signal sequence begins after a start of the cyclic motion is identified.

16. The method as recited in claim 15, wherein the steps a) to c) are cyclically repeated.

17. The method as recited in claim 14, further comprising:
storing the number of encoder signals of the recorded signal sequence which coincide with a possible signal sub-sequence of the reference signal sequence as a label value for the initial position associated with the corresponding signal sub-sequence.

18. The method as recited in claim 17, wherein the most recently recorded encoder signal of the recorded signal sequence is compared with the digit of each possible signal sub-sequence which follows the label value of the associated initial position.

19. The method as recited in claim 18, wherein a reverse search is carried out if no possible signal sub-sequence can be determined.

20. The method as recited in claim 19, wherein the reverse search includes a comparison of the recorded signal sequence with possible reverse signal sub-sequences which are formed by reading out the reference signal sequence in the opposite direction.

21. The method as recited in claim 18, wherein the method is used to determine the position of a camshaft of an internal combustion engine.

22. The method as recited in claim 21, wherein the encoder signals represent at least one of: (i) an indication of the presence or absence of a gap in a crankshaft encoder wheel; (ii) an indication of the presence of a camshaft encoder wheel; (iii) an angle of an edge of the camshaft encoder wheel; (iv) a length of a segment of the camshaft encoder wheel; and (v) a level of a segment of the camshaft encoder wheel.

23. The method as recited in claim 21, wherein the recording of the encoder signals is initially carried out with a selected first number of encoder signals per motion cycle, and subsequently a decreasing number of encoder signals per motion cycle is recorded.

24. The method as recited in claim 21, wherein the recording of the encoder signals is carried out at least eight times and at most thirty times per motion cycle.

25. A control unit for an internal combustion engine, the control unit being configured to determining an initial position of a cyclic motion of a camshaft of the engine, comprising:
means for recording successive encoder signals in order to obtain a signal sequence;
means for one of continuously or periodically comparing the recorded signal sequence with a group of possible signal sub-sequences of a reference signal sequence, the reference signal sequence encompassing a signal sequence of signal positions for at least one complete motion cycle, and the signal sub-sequences of the reference signal sequence each being associated with at least one possible initial position of the cyclic motion;
means for eliminating, from the group of possible signal sub-sequences, selected signal sub-sequences (i) which do not coincide with the recorded signal sequence or (ii) whose initial portions do not coincide with the recorded signal sequence; and
means for determining as the initial position one of the initial positions associated with the possible remaining signal sub-sequences of the reference signal sequence.

26. A non-transitory computer-readable data storage medium storing a computer program having program codes which, when executed on a computer, performs a method for determining an initial position of a cyclic motion of an apparatus, the method comprising:
a) recording successive encoder signals in order to obtain a signal sequence;
b) one of continuously or periodically comparing the recorded signal sequence with a group of possible signal sub-sequences of a reference signal sequence, the reference signal sequence encompassing a signal sequence of signal positions for at least one complete motion cycle, and the signal sub-sequences of the reference signal sequence each being associated with at least one possible initial position of the cyclic motion;
c) eliminating, from the group of possible signal sub-sequences, selected signal sub-sequences (i) which do not coincide with the recorded signal sequence or (ii) whose initial portions do not coincide with the recorded signal sequence; and
d) determining as the initial position one of the initial positions associated with the possible remaining signal sub-sequences of the reference signal sequence.
